(19) United States
(12) Patent Application Publication
(10) Pub. No.: US 2010/0080542 A1
(43) Pub. Date: Apr. 1, 2010

(54) INFRARED LED APPARATUS AND SURFACE HEATER

(75) Inventor: Russell Lewis Tartock, Springfield, IL (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/240,531

(22) Filed: Sep. 29, 2008

(51) Int. Cl. H05B 3/20

(52) U.S. Cl. 392/432

(57) ABSTRACT

An infrared LED apparatus and surface heater for heating complex surfaces that need to transmit light is disclosed. The infrared LED heater includes an infrared LED light source comprising a number of LEDs, which can be utilized to elevate the surface temperature of a lens utilizing less energy. The lens can be filled with an IR opaque and visible light transparent filler to elevate the lens surface temperature utilizing less energy. The filler is durable and opaque to infrared wavelengths and is transparent in the visible wavelengths. The infrared LED heaters can be utilized to heat complex surfaces that transmit light while consuming less energy than conventional resistive heaters.

### TECHNICAL FIELD

Embodiments are generally related to surface heaters. Embodiments are also related to infrared light emitting diode (LED) heaters.

### BACKGROUND OF THE INVENTION

Surface heaters generally include a resistive source or an incandescent infrared (IR) source for generating heat. Such surface heaters typically consume significant amounts of energy in order to generate heat. Additionally, the heaters need to be in close proximity to the surface to be heated or in need of a transport mechanism, such as a fan, to carry the heat energy to the surface. Surface mount heaters can be limited by the complexity of the surface. Similarly, proximity and forced transport heaters require additional power for the transport of heat to the surface and are inefficient.

Light emitting diodes (LEDs) are becoming increasingly common as LEDs provide a significantly more energy efficient light source than an incandescent lamp. Further, LEDs have significantly longer lifetimes than incandescent lamps. LED based air port lights need to have included an arctic kit that is designed to increase the temperature of the light's lens by 15° C. in 30 minutes at an ambient temperature of −20° C. The standard arctic kit employs a resistive heater that can be utilized to generate enough temperature to melt ice and snow from the optic lens of light fixtures at an ambient temperature.

Such resistive heaters, in order to radiate enough heat to melt ice and snow from the fixture optics, must consume large amounts of energy in order to generate heat. Hence, an infrared LED technology and materials that are durable and opaque to infrared wavelengths while being transparent in the visible wavelengths can be employed for generating heat.

Infrared energy has widely been utilized to join plastics. In general, it is necessary to have one IR transparent component and one IR opaque component. The IR energy is transmitted through the IR transparent material to the IR opaque material in order to generate heat that then melts the plastice to produce the weld. Interstitial materials have been developed for allowing joining two IR transparent components. The material is transparent to visible light while being opaque to IR wavelengths. This material can be applied to one surface. Such material dissipates and is lost during single operation and is unsuitable for repeated use. Materials have been designed as a filler for plastics that are opaque to infrared wavelengths and transparent in visible wavelengths so that two clear parts can be welded together. These materials are durable and can be energized by IR wavelengths repeatedly.

Based on the foregoing, it is believed that a need exists for an improved infrared heater for heating complex surfaces that need to transmit light while consuming less energy. It is believed that the improved infrared LED heater disclosed herein can address these and other continuing needs.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved surface and/or apparatus heater.

It is another aspect of the present invention to provide for an improved infrared LED heater utilizing IR opaque and visible light transparent filler.

It is a further aspect of the present invention to provide for an improved infrared LED heater for heating complex surfaces that transmit light.

The aforementioned aspects and other objectives and advantages can now be achieved as described herein. An infrared LED heater apparatus for heating complex surfaces that need to transmit light is disclosed. The infrared LED heater includes an infrared LED light source comprising a number of LEDs, which can be utilized to elevate the surface temperature of a lens utilizing less energy. The lens can be filled with an IR opaque and visible light transparent filler to elevate the lens surface temperature utilizing less energy. The filler is durable and opaque to infrared wavelengths and is transparent in the visible wavelengths. The infrared LED heaters can be utilized to heat complex surfaces that transmit light yet consume less energy.

Accordingly, an infrared heated lighting apparatus is described comprising at least one infrared LED, a lens associated with said infrared LED, said lens including material that is infrared opaque and transparent to visible light and is thereby adapted to elevate in temperature using less energy at an ambient temperature and access to a voltage controller adapted to provide electrical power to said infrared LED as needed to maintain a target temperature range

An infrared LED further includes a voltage controller and a power supply, which provides a constant current and/or a constant voltage to the LED light source. The infrared heater can be utilized to realize temperature rise of a surface from a given ambient temperature. The infrared LED heater can be utilized in LED-based airport lighting to increase the temperature of a light fixture's lens. The IR opaque fillers are transparent in visible wavelengths and can be applied to a wide variety of applications where the target surface needs to realize a temperature rise from a given ambient temperature. The infrared LED heater apparatus includes infrared LED technology and materials that are durable and opaque to infrared wavelengths while being transparent in the visible wavelengths; complex surfaces that need to transmit light can be heated while consuming less energy.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram depicting main components of an infrared LED heater, which can be implemented in accordance with a preferred embodiment;

FIG. 2 illustrates a perspective view of the infrared LED heater, which can be implemented in accordance with a preferred embodiment; and

FIG. 3 illustrates a side view of an airport runway including LED lighting in accordance with features of the present invention.

### DETAILED DESCRIPTION

The particular values and configurations discussed in these non-limiting examples can be varied and are cited merely to illustrate at least one embodiment and are not intended to limit the scope thereof.

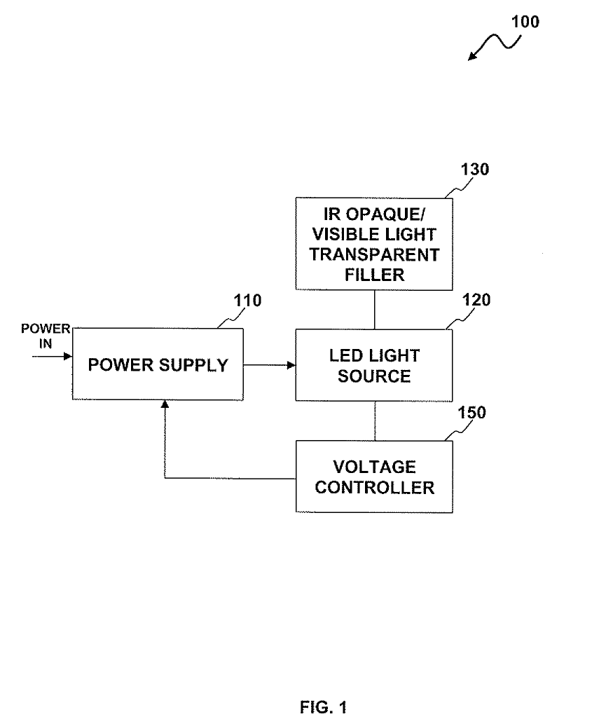

FIG. 1 illustrates a block diagram depicting components of an infrared LED heater system 100, in accordance with a preferred embodiment. Note that for purposes of this discussion, it should not be assumed that the infrared LED heater 100 functions primarily or exclusively as a heater for LED based airport lighting systems. It can be appreciated, as indicated above, that the apparatus 100 may also be utilized for heating complex surfaces that need to transmit light while consuming less energy. The apparatus 100 generally includes an infrared LED light source 120, a power supply 110 and a voltage controller 150.

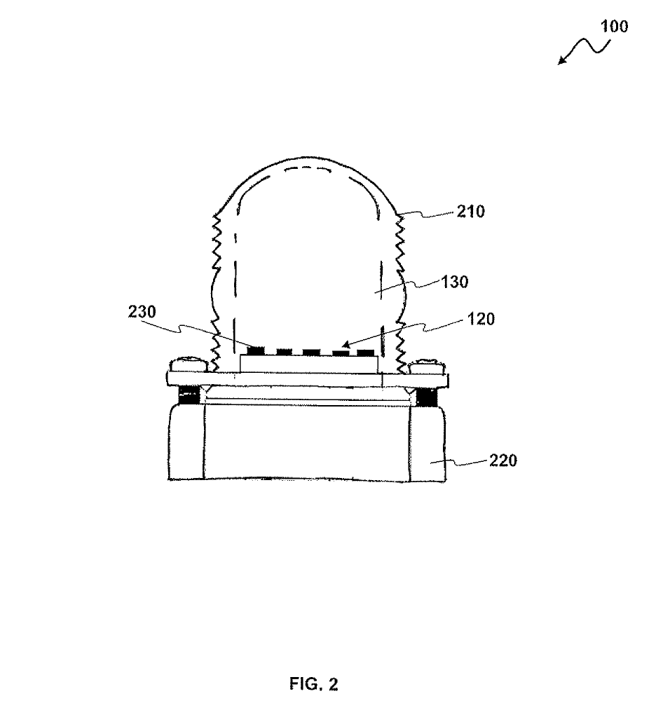

The infrared LED light source 120 can include a single LED, but can typically include a number of LEDs connected in series and can include a number of LEDs connected in parallel. Referring to FIG. 2, LED light source 120 further includes a lens 210 filled with filler 130 to elevate the surface temperature of the lens 210 utilizing less energy. The filler 130 is durable and opaque to infrared wavelengths and is transparent in visible wavelengths. The voltage controller 150 can be connected to the LED light source 120. The voltage controller 150 provides a feedback signal to the power supply 110 in order to control voltage and/or current. The power supply 110 can typically utilize the feedback signal to provide either a constant current or constant voltage to the LED source 120. By varying the feedback signal, more or less current can be sourced to the LED light source 120 to control the brightness output of the LED light source 120. The infrared LED heater apparatus 100 can be utilized to heat complex surfaces that transmit light by consuming less energy. The infrared LED heater 100 can be used in airport runway lights or taxiway lights.

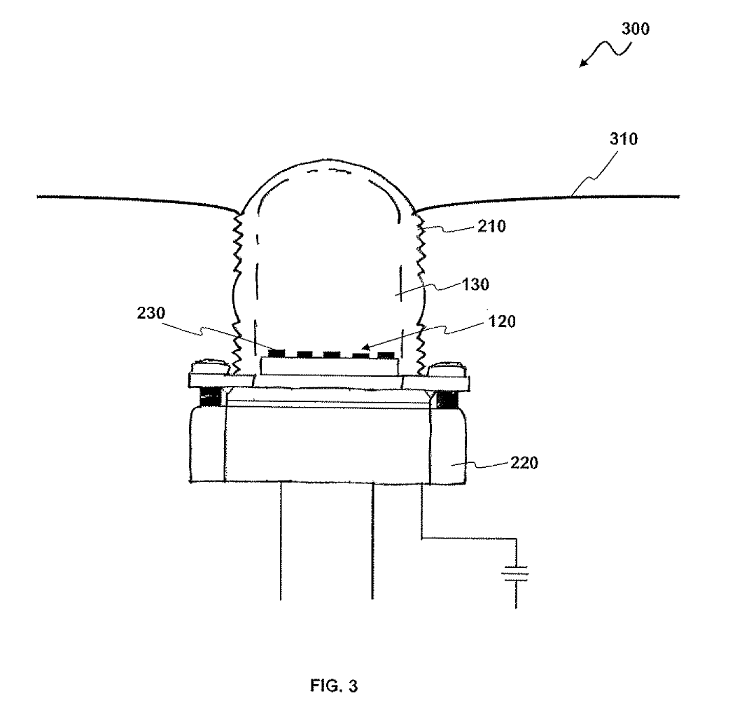

FIG. 3 illustrates a perspective view of the infrared LED apparatus heater 100 utilized in airport lights 300, in accordance with an application of the preferred embodiment. An airport runway 310 has installed therein LED lighting including several of apparatus 100, which each includes a light lens 210, which is filled with IR opaque and transparent in visible light filler 130. The filler 130 can be utilized to increase the temperature of the light lens 210 at an ambient temperature. The infrared light source 120 includes an infrared LED module 220, which includes a number of LEDs such as LED 230.

The infrared LED 230 can be utilized to elevate the surface temperature of the light lens 210. The power supply 110 can be utilized to provide electrical energy to the infrared LED module 220. The infrared LED heater apparatus 100 can be utilized to increase the temperature of a surface at an ambient temperature with in a time period. The apparatus 100 can be utilized to increase the temperature of fixture light lens 210 by 15° C. in 30 minutes at an ambient temperature of −20° C. Thus, a robust solution to LED based airport light fixtures are disclosed which can effectively increase the temperature of fixture lights lens 210 at an ambient temperature by utilizing less electrical energy.

Accordingly, an infrared heated lighting apparatus is described comprising at least one infrared LED, a lens associated with said infrared LED, said lens including material that is infrared opaque and transparent to visible light and is thereby adapted to elevate in temperature using less energy at an ambient temperature and access to a voltage controller adapted to provide electrical power to said infrared LED as needed to maintain a target temperature range.

The infrared LED heater apparatus 100 can be utilized to heat complex surface, which transmits light. The infrared LED heater apparatus 100 employs infrared LED technology and materials that are durable and opaque to infrared wavelengths while being transparent in the visible wavelengths; complex surfaces that need to transmit light can be heated while consuming less energy. The infrared LED heater apparatus 100 can also be utilized to generate infrared energy in industrial manufacturing processes such as curing of coatings, heating of plastic prior to forming, plastic welding, processing glass, cooking and browning food.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An infrared heater, comprising:
at least one infrared LED;
a surface associated with said infrared LED, said surface including material that is infrared opaque and is thereby adapted to elevate in temperature using less energy at an ambient temperature; and
access to a voltage controller adapted to provide electrical power to said infrared LED as needed to maintain a target temperature range.

2. The infrared heater of claim 1, said surface further comprising a lens that is transparent to visible light.

3. The apparatus of claim 2 including a filler material in said lens, wherein said filler is durable and opaque to infrared wavelengths and transparent in visible wavelengths.

4. The apparatus of claim 2 where in the lens is comprised of at least one of: glass and plastic.

5. The apparatus of claim 3 where in the lens is comprised of at least one of: glass and plastic.

6. The apparatus of claim 1 wherein said apparatus heats complex surfaces that need to transmit light by consuming less energy.

7. The apparatus of claim 2 wherein said apparatus heats complex surfaces that need to transmit light by consuming less energy.

8. The apparatus of claim 3 wherein said apparatus heats complex surfaces that need to transmit light by consuming less energy.

9. The apparatus of claim 2 wherein said apparatus can be utilized as an LED-based airport lights.

10. The apparatus of claim 3 wherein said apparatus can be utilized as an LED-based airport lights.

11. An infrared heated lighting apparatus, comprising:
at least one infrared LED;
a lens associated with said infrared LED, said lens including material that is infrared opaque and transparent in visible light and is thereby adapted to elevate in temperature using less energy at an ambient temperature; and
access to a voltage controller adapted to provide electrical power to said infrared LED as needed to maintain a target temperature range.

12. The apparatus of claim 11 including a filler material in said lens, wherein said filler is durable and opaque to infrared wavelengths and transparent in visible wavelengths.

13. The apparatus of claim 11 wherein said apparatus heats complex surfaces that need to transmit light by consuming less energy.

14. The apparatus of claim 11 wherein said apparatus can be utilized as an LED-based airport lights.

15. The apparatus of claim 11 where in the lens is comprised of at least one of: glass and plastic.

16. An infrared LED apparatus heater, comprising:
an infrared LED light source including at least one LED wherein said infrared LED light source in association with a voltage controller and a power supply provide a constant current and/or constant voltage to said infrared LED light source; and
a lens associated with said infrared LED light source includes an IR opaque and visible light transparent filler to elevate surface temperature of said lens utilizing less energy at an ambient temperature.

17. The apparatus of claim 16 wherein said filler is durable and opaque to infrared wavelengths and transparent in visible wavelengths.

18. The apparatus of claim 16 wherein said apparatus heat complex surfaces that need to transmit light while consuming less energy.

19. The apparatus of claim 16 wherein said apparatus can be utilized as an LED based airport lights.

20. The apparatus of claim 16 where in the lens is comprised of at least one of: glass and plastic.
